(19) United States
(12) Patent Application Publication
(10) Pub. No.: US 2014/0244503 A1
(43) Pub. Date: Aug. 28, 2014

(54) SYSTEM AND METHOD FOR AUTOMATIC THRESHOLDING FOR PAYMENT CARD SPEND CONTROL

(71) Applicant: MASTERCARD INTERNATIONAL INCORPORATED, Purchase, NY (US)

(72) Inventor: David SADLIER, Dublin (IE)

(73) Assignee: MasterCard International Incorporated, Purchase, NY (US)

(21) Appl. No.: 13/778,302

(22) Filed: Feb. 27, 2013

(51) Int. Cl. G06Q 20/40

(52) U.S. Cl. CPC G06Q 20/40
USPC 705/44

(57) ABSTRACT

A method for providing an automatic threshold for payment card controls includes: storing historical data for financial transactions involving a payment card; receiving an automatic threshold request, the request including a threshold model and a card use control; identifying a use threshold associated with the card use control based on an application of the threshold model to the historical data; receiving an authorization request for a financial transaction involving the payment card, the request including transaction data related to the financial transaction; and identifying if the use threshold is exceeded based on the transaction data and the card use control, wherein if the use threshold is exceeded, transmitting an authorization response indicating the threshold has been or will be exceeded by the financial transaction, and, if the use threshold is not exceeded, transmitting, an authorization response indicating approval with respect to not exceeding the threshold of the financial transaction.

### FIELD

The present disclosure relates to the automatic thresholding of controls on a payment card, specifically the use of a threshold model applied to historical transaction data to automatically identify a use threshold for a payment card control.

### BACKGROUND

Payment cards, such as credit cards, have become very widely used in society. In many instances, multiple cards may be associated with a single account, and each used separately to draw funds or to charge transactions to the shared account. In the case of families and companies, this may be beneficial as it may allow the account owner to monitor the usage of all others who possess a card associated with the account. However, in many instances, if a cardholder makes a purchase that is unauthorized by the account owner, the account owner may have no knowledge of it until after the fact when it appears on an account statement. In some instances, it may be too late for the account owner to dispute the transaction or to seek a return or refund from the merchant.

In order to address such problems, payment cards have been developed that include various controls. For example, MasterCard's® inControl™ platform allows an account owner to create custom controls for payment cards, also known as controlled payment numbers (CPNs), such as placing a limit on the amount of overall spending, the amount of spending on a single transaction, eligible merchants, the geographic area in which transactions may occur, number of transactions in a day or a given time period, etc. Additional detail regarding inControl™ and the use of CPNs to play controls on payment cards may be found in U.S. Pat. No. 6,636,833, issued Oct. 21, 2003; U.S. Pat. No. 7,136,835, issued Nov. 14, 2006; U.S. Pat. No. 7,571,142, issued Aug. 4, 2009; U.S. Pat. No. 7,567,934, issued Jul. 28, 2009; U.S. Pat. No. 7,593,896, issued Sep. 22, 2009; U.S. patent application Ser. No. 12/219,952, filed Jul. 30, 2008; U.S. patent application Ser. No. 12/268,063, filed Nov. 10, 2008; and U.S. patent application Ser. No. 12/359,971, filed Jan. 26, 2009; each of which are herein incorporated by reference in their entirety.

However, existing platforms that allow account owners to place controls on payment card usage can still be cumbersome to account owners. For account owners who have payment accounts where additional cards are issued to a large number of other people, such as a small business owner who distributes payment cards tied to a corporate account to each employee, managing card controls can be a difficult and time consuming task. Each employee may have different authority for purchases, and may have different circumstances that result in different levels of responsibility and different limits that should be assigned to the employee. For example, one employee may have no need to make any purchase above $25, another may need to be authorized for purchases between $50-$100, and another employee may have a need to be authorized for purchase over $500, but only with specific merchants and during specific periods of time. If such needs are carried out over a number of additional employees, such as a small business with twenty employees, determining and setting the limits for each individual employee may be a daunting task for an account owner that takes a large amount of time and resources.

Thus, there is a need for a technical solution to provide automatic thresholds for payment card use controls that allow an account owner to control the use of payment cards associated with the account and monitor such use, without expending the time and resources necessary to manually manage the controls on each payment card.

### SUMMARY

The present disclosure provides a description of a systems and methods for the identification of merchant debit routing tables.

A method for providing an automatic threshold for payment card controls includes: storing, in a transaction database, historical data for a plurality of financial transactions involving a payment card; receiving, by a receiving device, an automatic threshold request, wherein the automatic threshold request includes at least an indication of a threshold model selected from a plurality of threshold models and a payment card use control; identifying, by a processing device, a use threshold associated with the payment card use control based on an application of the selected threshold model to the historical data stored in the transaction database; receiving, by the receiving device, an authorization request for a financial transaction involving the payment card, wherein the authorization request includes transaction data related to the financial transaction; and identifying, by the processing device, if the use threshold is exceeded based on the transaction data and the payment card use control, wherein if the use threshold is exceeded, transmitting, by a transmitting device, an authorization response indicating the threshold has been or will be exceeded by the financial transaction, and, if the use threshold is not exceeded, transmitting, by the transmitting device, an authorization response indicating approval with respect to not exceeding the threshold of the financial transaction.

A system for providing an automatic threshold for payment card controls includes a transmitting device, a transaction database, a receiving device, and a processing device. The transaction database is configured to store historical data for a plurality of financial transactions involving a payment card. The receiving device is configured to receive an automatic threshold request, wherein the automatic threshold request includes at least an indication of a threshold model selected from a plurality of threshold models and a payment card use control. The processing device is configured to identify a use threshold associated with the payment card use control based on an application of the selected threshold model to the historical data stored in the transaction database. The receiving device is further configured to receive an authorization request for a financial transaction involving the payment card, wherein the authorization request includes transaction data related to the financial transaction. The processing device is further configured to identify if the use threshold is exceeded based on the transaction data and the payment card use control. If the use threshold is exceeded, the transmitting device is configured to transmit an authorization response indicating the threshold has been or will be exceeded by the financial transaction. If the use threshold is not exceeded, the transmitting device is configured to transmit an authorization response indicating approval with respect to not exceeding the threshold of the financial transaction.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for providing automatic thresholding for payment card use controls in accordance with exemplary embodiments.

FIG. 2 is a block diagram illustrating an embodiment of a processing server for use in the system of FIG. 1 in accordance with exemplary embodiments.

FIGS. 3A and 3B are a processing flow illustrating a method for establishing automatic thresholds for payment card use controls and the processing of a financial transaction based on the automatic thresholds in accordance with exemplary embodiments.

FIG. 4 is a diagram illustrating a threshold model for use in establishing automatic thresholds for payment card use controls in accordance with exemplary embodiments.

FIGS. 5A-5F are diagrams illustrating a graphical user interface for the establishing and managing of automatic thresholds for payment card use controls in accordance with exemplary embodiments.

FIG. 6 is a flow chart illustrating an exemplary method for providing an automatic threshold for payment card controls in accordance with exemplary embodiments.

FIG. 7 is a block diagram illustrating computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, etc.

Payment Account—A financial account that may be used to fund a transaction, such as a checking account, savings account, credit account, virtual payment account, etc. A payment account may be associated with an entity, which may include a person, family, company, corporation, governmental entity, etc. In some instances, a payment account may be virtual, such as those accounts operated by PayPal®, etc.

Payment Card—A card or data associated with a payment account that may be provided to a merchant in order to fund a financial transaction via the associated payment account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated payment account (e.g., as stored in a communication device, such as a smart phone or computer). For example, in some instances, data including a payment account number may be considered a payment card for the processing of a transaction funded by the associated payment account. In some instances, a check may be considered a payment card where applicable.

### System for Providing Automatic Thresholding for Payment Card Use Controls

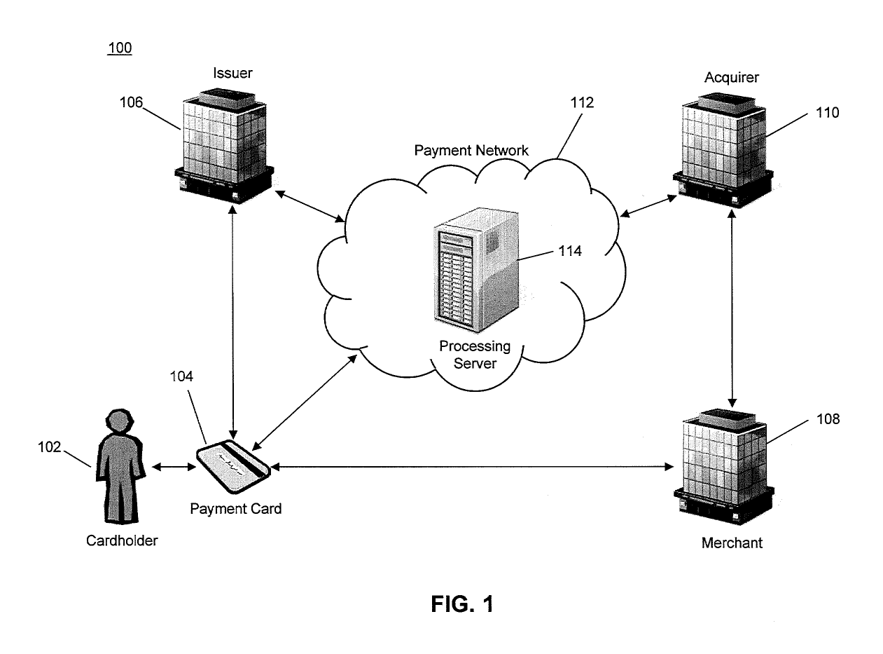

FIG. 1 is a block diagram illustrating a system 100 for the providing of automatic thresholds for payment card use controls. The system 100 may include a cardholder 102. The cardholder 102 may have a payment card 104 issued to the cardholder 102 by an issuer 106, such as an issuing bank. The payment card 104 may be associated with a payment account (e.g., a credit card account) with the issuer 106.

The cardholder 102 may initiate a financial transaction for the purchase of goods or services with a merchant 108. The cardholder 102 may present the payment card 104 for funding of the financial transaction, which may be read (e.g., scanned, imprinted, etc.) by the merchant 108. The merchant 108 may then submit transaction details (e.g., transaction amount, transaction time and/or date, etc.) for the financial transaction including information (e.g., account number, etc.) for the payment card 104 to an acquirer 110, such as an acquiring bank. The acquirer 110 may submit an authorization request for the financial transaction to a payment network 112 for processing. In one embodiment, the authorization request may be formatted pursuant to the International Organization for Standardization's ISO 8583 standard. In some embodiments, the merchant 108 may directly submit the authorization request to the payment network 112.

The payment network 112 may be configured to process the financial transaction. The payment network 112 may include a processing server 114. The processing server 114, discussed in more detail below, may be configured to store and manage use controls for the payment card 104. In some embodiments, the use controls may be identified by the cardholder 102. In other embodiments, the use controls may be identified by a user other than the cardholder 102, such as an owner of the payment account associated with the payment card 104, such as if the cardholder 102 is an employee of a company and the payment card 104 a corporate card.

In an exemplary embodiment, the account owner and/or cardholder 102 may identify at least one use control, and may identify a threshold model, discussed in more detail below. The processing server 114 may, using the identified threshold model and historical transaction data for the cardholder 102 and/or the payment card 104, automatically identify at least one threshold for the identified at least one use control. In some embodiments, a single threshold model may be used to identify multiple use controls. In other embodiments, each use control may be identified using an individually selected threshold model. In some instances, some use controls may be identified via automatic threshold based on threshold models, while other use controls may be based on limits established by the account owner.

The processing server 114 may identify, from the authorization request, the payment card 104 used in the financial transaction. The processing server 114 may then identify the use controls associated with the payment card 104 and may determine, based on the use controls, if one or more use thresholds are exceeded by the financial transaction. For example, the processing server 114 may have identified an automatic threshold on overall spending for the payment card 104, and may determine if the financial transaction would exceed the overall spending threshold (e.g., by the transaction amount for the financial transaction exceeding the automatically identified overall spending limit).

The processing server 114 may then transmit an authorization response for the financial transaction to the acquirer 110 and/or the merchant 108 via the payment network 112, indicating if the financial transaction is approved or denied based on the use controls. In instances where use controls are not exceeded, the transaction information may first be transmitted to the issuer 106 for approval of the financial transaction (e.g., based on the transaction amount and an available credit limit), and subsequent approval or denial by the issuer 106 used in determining if the authorization response is to indicate approval or denial of the financial transaction.

In some instances, the processing server 114 may be configured to transmit a notification of the financial transaction to the cardholder 102 and/or an account owner of the payment account associated with the payment card 104. For example, if a transaction is denied for exceeding a use control threshold, then the processing server 114 may transmit (e.g., via the payment network 112) a notification to the account owner of the attempted use of the payment card in a transaction exceeding the use control threshold. In some embodiments, notifications may be transmitted based on the same threshold model used for establishing the automatic use control threshold, as discussed in more detail below.

### Processing Server

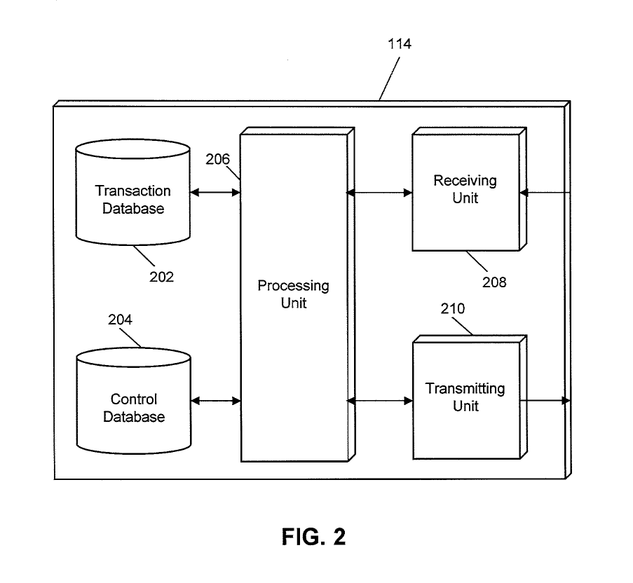

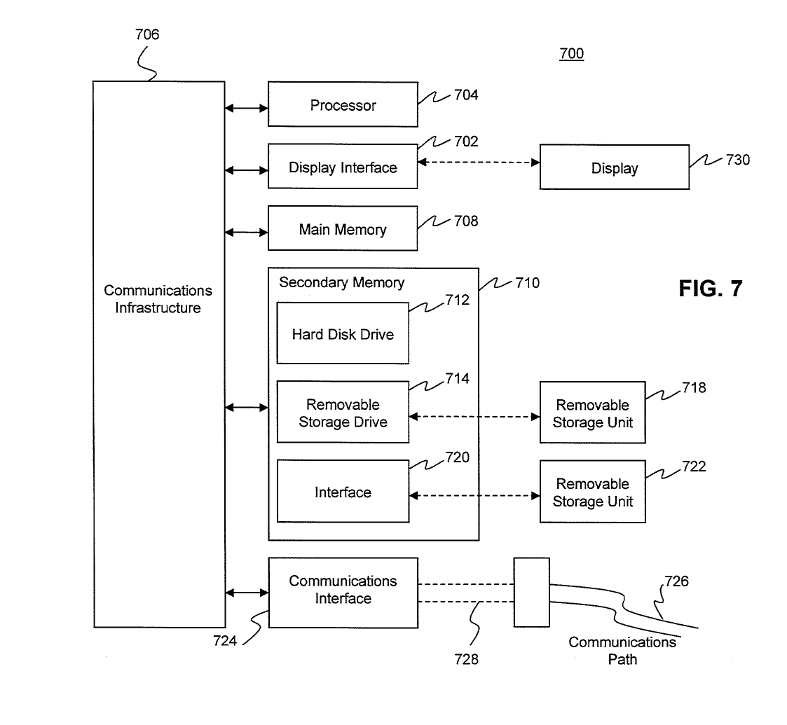

FIG. 2 illustrates an embodiment of the processing server 114 of the system 100. It will be apparent to persons having skill in the relevant art that the embodiment of the processing server 114 illustrated in FIG. 2 is provided as illustration only and may not be exhaustive to all possible configurations of the processing server 114 suitable for performing the functions as discussed herein. For example, the computer system 700 illustrated in FIG. 7 and discussed in more detail below may be a suitable configuration of the processing server 114.

The processing server 114 may include a transaction database 202. The transaction database 202 may be configured to store historical data for a plurality of financial transactions involving the payment card 104. In some embodiments, the historical data may alternatively include a plurality of financial transactions involving the cardholder 102. The historical data may include any transaction data suitable for use in the determination of payment card use control thresholds as will be apparent to persons having skill in the relevant art, such as transaction amounts, merchant information, geographic location of the transactions, time and/or date of the transactions, etc.

The processing server 114 may also include a control database 104. The control database 104 may be configured to store payment card use control information for controls on a plurality of payment cards including the payment card 104. Payment card use control information may include, as will be apparent to persons having skill in the relevant art, a payment card use control, a threshold model, at least one automatically identified threshold, and information identifying the associated payment card (e.g., a payment card number). In some instances, a single entry may be used for each threshold, while in other instances, separate entries may be used for each threshold for a single use control (e.g., an entry for an upper transaction threshold, an entry for an alert threshold, an entry for a lower transaction threshold, etc.).

The processing server 114 may further include a receiving unit 208. The receiving unit 208 may be configured to receive an automatic threshold request from a user, such as the cardholder 102 or an account owner of a payment account for which the payment card 104 is associated. The automatic threshold request may include at least a selected threshold model, a payment card use control, and a payment account identifier, such as the payment card number for the payment card 104. The processing server 114 may include a processing unit 206, which may store a new entry in the control database 204 based on the received automatic threshold request. In some embodiments, the automatic threshold request may include an indication of which thresholds are to be automatically identified.

The processing unit 206 may then identify, in the transaction database, the historical data for the payment card 104 for which an automatic threshold was requested. The processing unit 206 may then, based on the identified historical data, the selected threshold model, and the payment card use control, identify at least one automatic threshold, as discussed in more detail below.

The receiving unit 208 may be further configured to receive an authorization request for a financial transaction involving the payment card 104. The authorization request may include at least a transaction amount, a merchant identifier (e.g., a merchant identification number), a transaction time and/or date, and information identifying the payment card 104 as used to fund the financial transaction. The processing unit 206 may identify payment card use controls associated with the payment card 104 in the control database 204. The processing unit 206 may then identify if any of the payment card use control thresholds associated with the payment card 104 are exceeded based on the transaction data included in the authorization request.

If the payment card use control thresholds are exceeded, then a transmitting unit 210 may transmit an authorization response back to the originator of the authorization request (e.g., the merchant 108 and/or the acquirer 110) indicating that the financial transaction is to be denied. In some instances, the transmitting unit 210 may further transmit a notification to an account owner or other entity of the denied transaction. In such an instance, the processing server 114 may store account information for the payment account to which the payment card 104 is associated. The account information may include a preferred method of contact and contact information, such as for the transmitting of notifications to the account owner or other entity as indicated in the account information. Methods of notifying an entity of a denied transaction will be apparent to persons having skill in the relevant art and include e-mail, short message service (SMS) message, multimedia service (MMS) message, telephone, etc.

In some instances, the payment card 104 may exceed only an alert threshold. In such an instance, the transaction may be approved, but the transmitting unit 210 may still transmit an alert to the account owner, cardholder 102, or other entity regarding the financial transaction. For example, the cardholder 102 may be authorized by the account owner for all transactions up to $1,000 for business purposes, but may request an alert for any transaction below $10 to identify transactions where the cardholder 102 may be potentially using a corporate card for personal reasons, such as an unauthorized lunch.

If the processing unit 206 determines that no payment card use control threshold is exceeded, then the transmitting unit 210 may transmit relevant transaction information, such as the transaction amount and payment card information, to the issuer 106. The issuer 106 may determine if the transaction is to be approved, such as based on an account balance or available credit, and may transmit a response to the processing server 114 to be received by the receiving unit 208. The transmitting unit 210 may then transmit an authorization response back to the merchant 108 and/or acquirer 110 indicating approval or denial of the financial transaction as indicated by the issuer 106.

In some embodiments, the processing unit 206 may update the historical data included in the transaction database 202 following approval of the financial transaction. In further embodiments, the processing unit 206 may also update the automatic payment card use control thresholds for the payment card 104 based on the updated historical data. In some instances, the processing unit 206 may update the automatic thresholds at predetermined periods of time, such as weekly, monthly, etc., which may be determined by the account owner (e.g., and stored in account information).

### Method for Identifying and Processing Automatic Thresholds

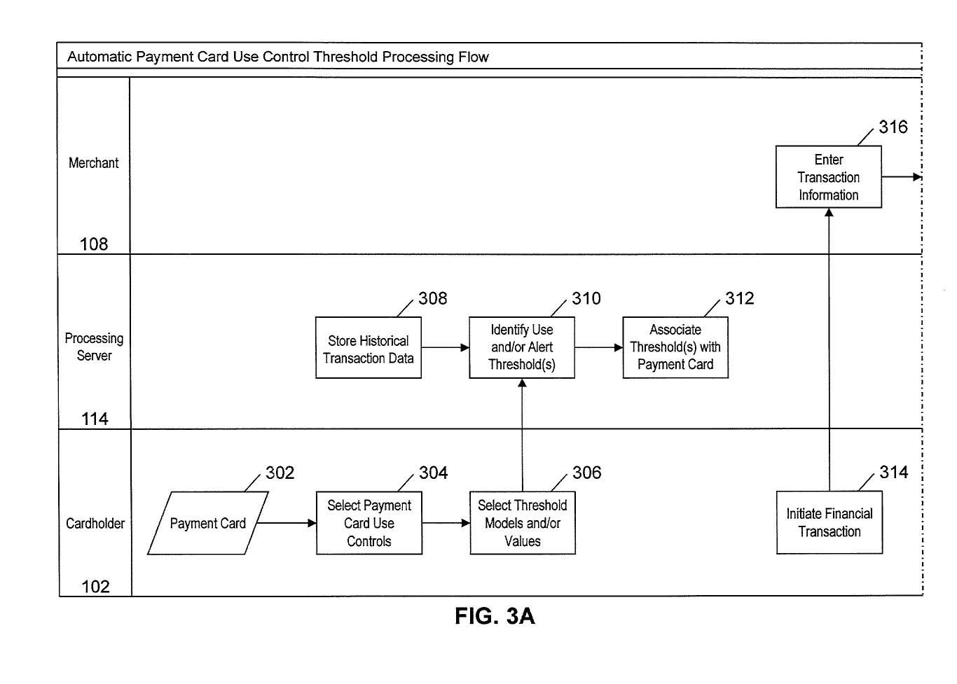

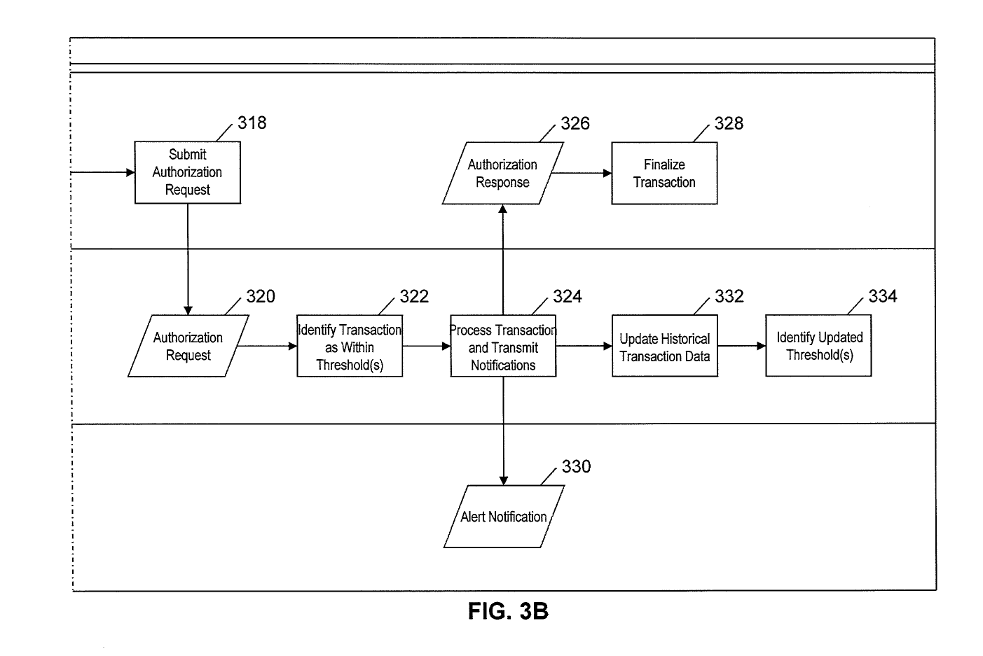

FIGS. 3A and 3B illustrate a processing flow for automatically identifying payment card use control thresholds and processing financial transactions based thereon.

In step 302, the cardholder 102 may receive the payment card 104 as issued by the issuer 106. It will be apparent to persons having skill in the relevant art that the description of the method of FIGS. 3A and 3B with reference to the cardholder 102 being the account owner of the payment account to which the payment card 104 is associated is for the purposes of illustration only, and that in some instances the account owner may not be the cardholder of the payment card for which automatic thresholds are identified and used.

In step 304, the cardholder 102 may select at least one payment card use controls to be applied to the payment card 104 from a plurality of payment card use controls. Payment card use controls may include controls on transaction amount, merchant name, merchant industry, geographic location, purchase order number, transaction time, transaction date, gratuity, expense type, and transaction frequency. In step 306, the cardholder 102 may select a threshold model from a plurality of threshold models for use in identifying automatic thresholds for each of the selected payment card use controls. In some instances, the cardholder 102 may select an individual model for each payment card use control, while in other instances the cardholder 102 may select a single model for a plurality of, or all, payment card use controls.

In some embodiments, the cardholder 102 may select custom values to identify a custom threshold model to be used to automatically identify use control thresholds. Threshold models for use in identifying automatic thresholds for payment card use controls may include an outlier percentage, a Gaussian model, Chauvenet's criterion, Grubbs' test, Perice's criterion, or any other model suitable for use in automatically identifying thresholds as will be apparent to persons having skill in the relevant art.

In step 308, the processing server 114 may store historical transaction data for financial transactions involving the payment card 104 and/or the consumer 102 in the transaction database 202. In step 310, the processing server 114 may identify use and/or alert thresholds for the payment card 104 for each payment card use control selected by the cardholder 102, based on the stored historical transaction data and the selected threshold model. The identification of thresholds based on historical data and a threshold model is discussed in more detail below. In step 312, the processing server 114 may associate the identified thresholds with the payment card 104, such as by storing the use control and threshold information in the control database 204 associated with the payment card 104.

In step 314, the cardholder 102 may initiate a financial transaction with the merchant 108 for the purchase of goods and/or services. In step 316, the merchant 108 may enter transaction information for the financial transaction information into a point-of-sale system, where the transaction information includes at least the payment card number for the payment card 104 for use in funding the financial transaction. In step 318, the merchant 108 (e.g., or the acquirer 110 on behalf of the merchant 108) may submit an authorization request for the financial transaction to the processing server 114 via the payment network 112.

In step 320, the processing server 114 may receive the authorization request, which may include at least the payment card number and transaction data related to the financial transaction. The transaction data may include transaction amount, merchant name, merchant industry, geographic location, purchase order number, transaction time, transaction date, gratuity, and expense type. In step 322, the processing server 114 may identify the use and/or alert thresholds associated with the payment card 104 used in the financial transaction and may identify that, for example, the transaction is within the use threshold but exceeds an alert threshold as illustrated in FIG. 3B.

In step 322, the processing server 114 may process the financial transaction using traditional systems and methods that will be apparent to persons having skill in the relevant art, and may transmit any necessary notifications. The processing server 114 may transmit an authorization response to the merchant 108 indicating approval of the financial transaction, which may be received by the merchant 108 in step 326. Then, in step 328, the merchant 108 may finalize the financial transaction, such as by providing the transacted for goods or services to the cardholder 102, furnishing the cardholder 102 with a receipt, etc. The processing server 114 may also transmit an alert notification to the cardholder 102 (e.g., or the account owner) indicating that the financial transaction exceeding an automatically identified alert threshold.

In step 332, the processing server 114 may update the historical transaction data stored in the transaction database 202 with the transaction data in the financial transaction. Then, in step 334, the processing server 114 may update the alert and/or use thresholds for the payment card 104 based on the updated historical data.

### Automatic Payment Card Use Control Thresholds

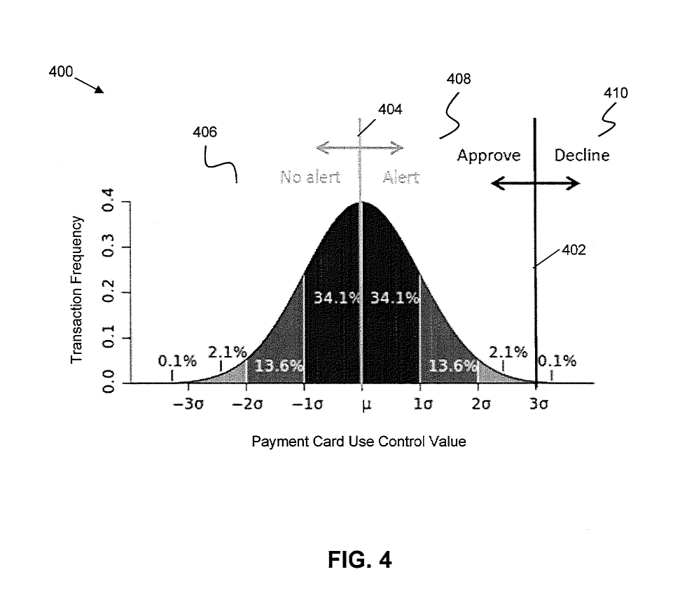

FIG. 4 is an illustration of a threshold model 400 used for automatically identifying thresholds for a payment card use control for the payment card 104. The use of transaction frequency as the payment card use control is provided as a means of illustration only. It will be apparent to persons having skill in the relevant art that different payment card use controls may have thresholds automatically identified via similar methods and systems.

The cardholder 102 may select transaction frequency as a desired payment card use control. The processing server 114 may identify the average transaction frequency for the payment card 104 based on the historical transaction data included in the transaction database 202. The average transaction frequency may be represented in the threshold model 400 by the mean value 404. As illustrated in FIG. 4, the cardholder 102 and/or account owner may select the mean value 404 to serve as an alert threshold limit, such that if the alert threshold limit is exceeded, the account owner is to be notified. For example, as illustrated in FIG. 4, if the transaction frequency for the payment card exceeds the mean value 404, such as those days included in the region 408, then the account owner may be notified. Conversely, for days in the region 406 where less than the mean value 404 are performed, then the account owner may receive no notification.

The processing server 114 may automatically identify the alert threshold based on the threshold model 400 and the historical transaction data. For example, the processing server 114 may identify that the average number of transactions processed per day using the payment card 104 may be three. Accordingly, the processing server 114 may then establish the alert threshold to be at three transactions per day, such that it may alert the cardholder 102 on a day where four or more transactions occur. The automatic identification of the threshold by the processing server 114 may enable the cardholder 102 to place an alert on the payment card 104, without expending the time and resources necessary to identify a specific value. Rather than having to go back through a large number of financial transactions to calculate transaction frequencies, and then establish an average, the cardholder 102 may merely select the threshold model 400 and select the mean value 404 as the alert threshold, which the processing server 114 can identify as being three transactions per day.

The threshold model 400 may also be used to identify a use threshold, such that if an attempted financial transaction exceeds the use threshold, then the transaction may be denied. For example, the cardholder 102 may indicate that a use threshold should be identified at three standard deviations above the mean transaction frequency, illustrated in FIG. 4 as the use threshold 402. The processing server 114 may automatically identify a value to serve as the use threshold 402 based on the mean and standard deviation of the transaction frequency for the payment card 104 based on the historical transaction data, and may establish a use control with the corresponding threshold in the control database 204. For example, the transaction frequency at three standard deviations may be identified to be six transactions, such that the processing server 114 may deny any transactions beyond the sixth transaction (e.g., or also the sixth transaction, if indicated by the cardholder 102), such as those days represented in region 410.

In some embodiments, the processing server 114 may be configured to automatically update the payment card use control thresholds based on updated historical transaction data. For example, the processing server 114 may store new transaction data in the transaction database 202 for transactions involving the payment card 104. The new transaction data may indicate that the payment card 104 is being used daily for four transactions, and still commonly up to the authorized six transactions a day. Based on the increased activity, the processing server 114 may identify a new alert threshold occurring at four transactions per day (the new mean value 404), and may identify a new use threshold occurring at eight transactions per day (the new use threshold 402) as a result of a larger standard deviation due to the higher transaction frequency.

In some embodiments, the processing server 114 may automatically identify new thresholds any time the historical transaction data is updated. In other embodiments, new thresholds may be automatically identified at a predetermined time. In a further embodiment, the predetermined time may be a time interval. For example, the cardholder 102 may request that new thresholds be automatically identified for the payment card 104 at the beginning of every month. In some instances, the processing server 114 may notify the cardholder 102 of new thresholds when they are identified, to provide the cardholder 102 with an opportunity to adjust the threshold model 400.

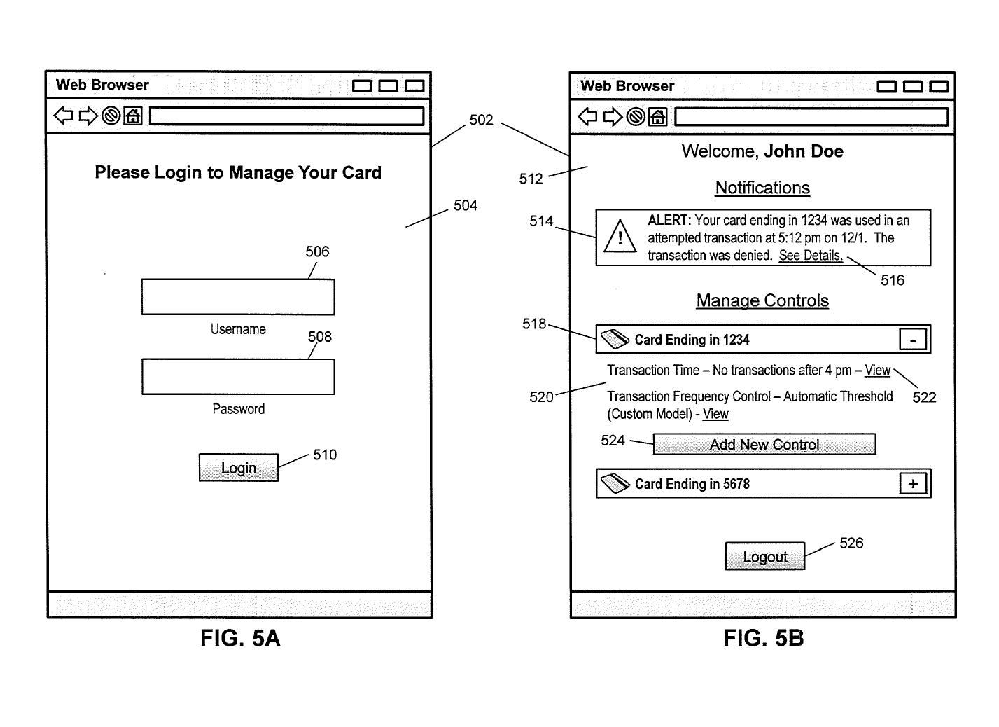

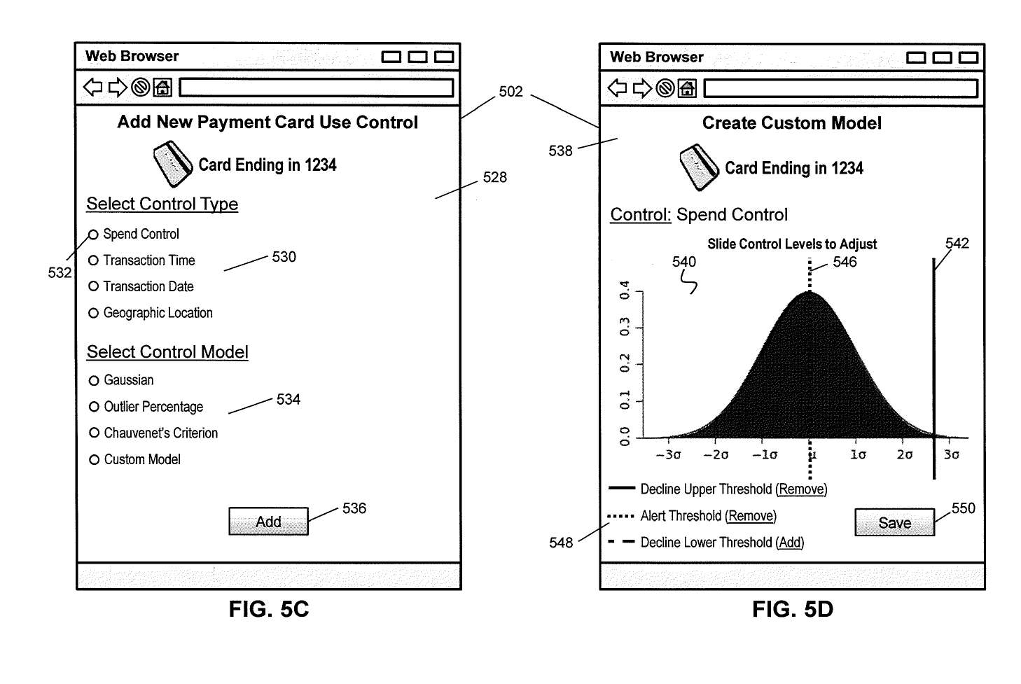

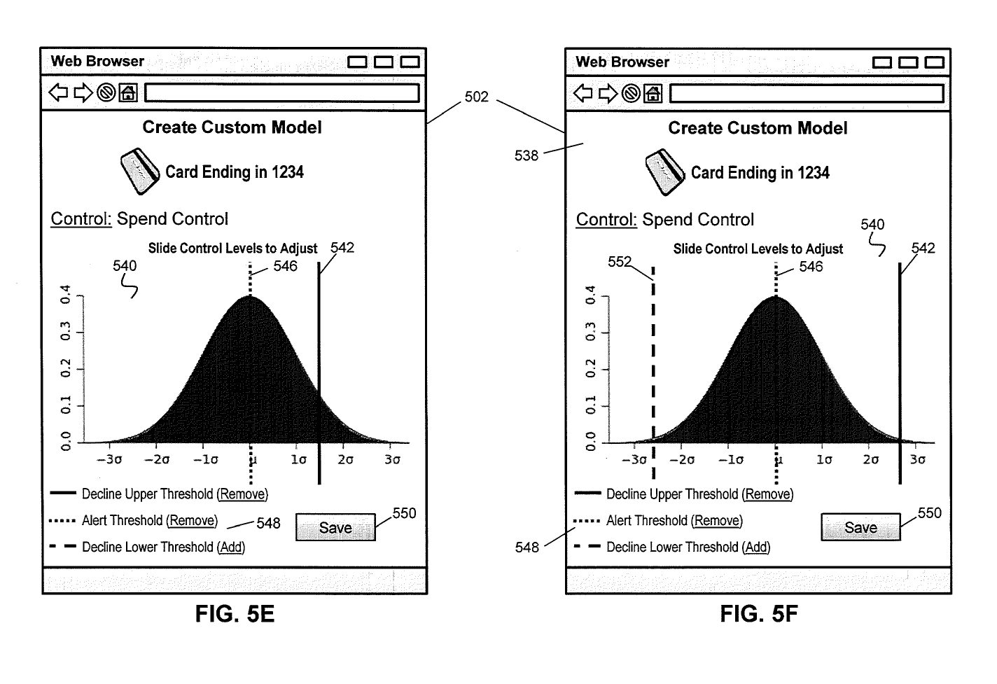

It will be apparent to persons having skill in the relevant art that the threshold model 400 may be customized by the cardholder 102 or may be a predetermined model, such as a Gaussian model. In addition, thresholds may be identified by the cardholder 102 based on any suitable value or metric, such as mean values, standard deviations, interquartile ranges, etc. In some instances, as discussed in more detail below with respect to FIGS. 5D-5F, the cardholder 102 may be provided with a graphical interface for the threshold model 400 and may use a slider to adjust thresholds on a graphical representation of the payment card use control values, such as illustrated in FIG. 4.

### Graphical User Interface

FIGS. 5A-5F illustrate an exemplary graphical user interface to enable the cardholder 102 to select payment card use controls and threshold models for the use in creating automatic thresholds. It will be apparent to persons having skill in the relevant art that the graphical user interfaces depicted herein are provided as an illustration only, and that additional interfaces may be suitable for performing the functions as disclosed herein as will be apparent to persons having skill in the relevant art.

FIG. 5A illustrates a web browser 502, such as displayed by a web browsing application or other application program on a computing device, for display of a webpage. Computing devices and application programs suitable for displaying a webpage will be apparent to persons having skill in the relevant art. It will be further apparent to persons having skill in the relevant art that the interface as illustrated herein may alternatively be displayed in an application program (e.g., executed by a computing device, such as a smart phone).

The web browser 502 may display a login webpage 504, as illustrated in FIG. 5A. The login webpage 504 may include a username field 506 and a password field 508. The user (e.g., the cardholder 102) may input a username and password into the respective fields in order to authenticate the cardholder 102 and identify the corresponding account. The login webpage 504 may include a login button 510, which, when interacted with by the cardholder 102, may transmit the data in the username field 506 and password field 508 to the server (e.g., the processing server 114 or a web server operated by or on behalf of the processing server 114).

Once the authentication information has been submitted, the processing server 114 may identify the account and may display, as illustrated in FIG. 5B, an account webpage 512. The account webpage 512 may display to the cardholder 102 any alerts and payment cards they are associated with for viewing and/or managing. For example, the account webpage 512 may display the alert 514, which notifies the cardholder that a payment card ending in 1234 was used in an attempted transaction and denied. The alert 514 may include a details link 516, which, when selected by the cardholder 102, may display additional details regarding the denied transaction.

The account webpage 512 may also display at least one payment card listing 518 associated with the cardholder 102. The payment card listing 518 may include information regarding card use controls associated with the corresponding payment card, such as the card use controls 520. Each card use control 520 may include a view link 522, which, when interacted with by the cardholder, may display additional details regarding the use control, such as any alerted and/or denied transactions based on the control, changes in the automatic threshold, fields for editing the existing use control, etc. The account webpage 512 may also include a logout button 526, which may navigate the cardholder 102 away from the webpage and may log the cardholder 102 out such that the detailed account information may no longer be accessible without providing authentication again.

The account webpage 512 may also include a new control button 524 for each payment card in the payment card listing 518. The new control button 524 may be interacted with by the cardholder 102 to begin a process for adding a new automatic threshold control to the corresponding payment card. Once the button 524 is pressed, the web browser 502 may display the selection webpage 528 as illustrated in FIG. 5C. The selection webpage 528 may display a control selection 530 and a model selection 534. The control selection 530 may include a plurality of radio buttons 532 for the selection of a payment card use control of a plurality of payment card use controls. As illustrated in FIG. 5C, the payment card use controls may include spend control, transaction time, transaction date, and geographic location. The model selection 534 may include radio buttons 532 for the selection of a threshold model for use in creating the automatic thresholds, such as a Gaussian model, outlier percentage, Chauvenet's criterion, or a custom model.

The selection webpage 528 may further include an add button 536, which, when interacted with by the cardholder, may cause the web browser 538 to navigate to the custom model webpage 538 illustrated in FIG. 5D. It will be apparent to persons having skill in the relevant art that the custom model webpage 538 may be displayed if the cardholder 102 selects the custom model in the model selection 534, and that other webpages may be displayed dependent on the model selection 534. The custom model webpage 538 may be designed to enable the cardholder 102 to identify levels for use in creating automatic thresholds for the selected payment card use control.

The custom model webpage 538 may include a model representation 540. The model representation 540 may be a standard representation as illustrated in FIG. 5D. In some instances, the model representation 540 may be a graphic representation of historical transaction data for the corresponding payment card, which may include specific values in the x- and/or y-axis corresponding to the transaction data and the payment card use control. For example, the mean value μ may be replaced by the actual mean transaction amount based on historical transaction data, and each a value may be replaced by the corresponding transaction amount based on the standard deviation (a). In some embodiments, the cardholder 102 may be presented with an option to select between representations.

The model representation 540 may include a use threshold 542 and an alert threshold 546. The cardholder 102 may be enabled to slide the use threshold 542 and the alert threshold 546 to adjust the levels to those desired. For example, as illustrated in FIG. 5D, the use threshold 542 may be at 2.5σ, which may indicate denial of any transaction with a transaction amount two and a half standard deviations above the mean transaction amount. As illustrated in FIG. 5E, the cardholder 102 may adjust the slider (e.g., via click-and-drag, mouse wheel, arrow keys, graphical arrows, etc.) such that the use threshold 542 is moved to 1.5σ.

The custom model webpage 538 may further include a legend 548, which may provide the cardholder 102 with an indication as to which slider corresponds to what threshold, may be provide the cardholder 102 with the ability to add or remove each type of threshold. For example, the cardholder 102 may add a lower use threshold 552, as illustrated in FIG. 5F. The lower use threshold 552 may be adjusted and indicate that any financial transactions with a transaction amount being below the lower use threshold 552, −2.5σ, or two and a half standard deviations below the mean value, illustrated in FIG. 5F, should be denied. In some embodiments, the cardholder 102 may be able to further add a lower alert threshold. Additional thresholds that may be used will be apparent to persons having skill in the relevant art.

In some embodiments, the custom model webpage 538 may further include notification information, such as to identify a preferred method of contact and/or contact information to receive alerts based on the alert threshold 546. The custom model webpage 538 may also include a save button 550. The cardholder 102 may interact with the save button 550 to save the customized model, which will transmit the selected levels and information to the processing server 114. The processing server 114 may then identify the threshold values based on the levels indicated by the cardholder 102 and the historical transaction data, and enter a new payment card use control in the control database 204 for the selected use control and the indicated levels and threshold values.

### Method for Providing an Automatic Threshold for Payment Card Controls

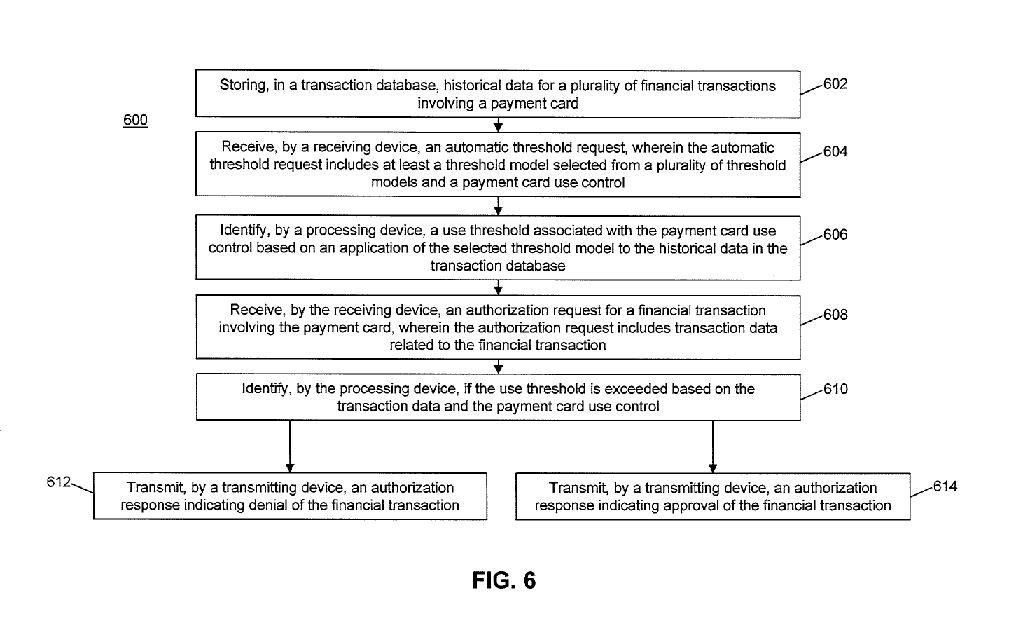

FIG. 6 illustrates a method 600 for providing an automatic threshold for payment card controls using the system 100 of FIG. 1.

In step 602, historical data for a plurality of financial transactions involving a payment card (e.g., the payment card 104) may be stored in a transaction database (e.g., the transaction database 202). In some embodiments, the historical data may include, for each financial transaction of the plurality of financial transactions, at least one of: transaction amount, merchant name, merchant industry, geographic location, purchase order number, transaction time, transaction date, gratuity, and expense type.

In step 604, an automatic threshold request may be received by a receiving device (e.g., the receiving unit 208), wherein the automatic threshold request includes at least a threshold model (e.g., the threshold model 400) selected from a plurality of threshold models and a payment card use control. In one embodiment, the plurality of threshold models may include at least one of: an outlier percentage, a Gaussian model, Chauvenet's criterion, Grubbs' test, Peirce's criterion, a value relative to a mean payment card use control value, and a value of standard deviations. In some embodiments, the payment card use control may be a control on at least one of: transaction amount, merchant name, merchant industry, geographic location, purchase order number, transaction time, transaction date, gratuity, expense type, and transaction frequency.

In step 606, a use threshold (e.g., the use threshold 402) associated with the payment card 104 may be identified, by a processing device (e.g., the processing unit 206, based on an application of the selected threshold model 400 to the historical data in the transaction database 202. In one embodiment, the use threshold 402 may be at least one of: an upper use threshold and a lower use threshold.

In step 608, an authorization request for a financial transaction may be received, by the receiving device 208, wherein the authorization request includes transaction data related to the financial transaction. In one embodiment, the transaction data related to the financial transaction may include at least one of: transaction amount, merchant name, merchant industry, geographic location, purchase order number, transaction time, transaction date, gratuity, and expense type. In step 610, the processing device 206 may identify if the use threshold 402 is exceeded based on the transaction data and the payment card use control. If, in step 610, it is determined that the use threshold 402 is exceeded, then, in step 612, a transmitting device (e.g., the transmitting unit 210) may transmit an authorization response indicating denial of the financial transaction.

If, in step 610, it is determined that the use threshold 402 is not exceeded, then, in step 614, the transmitting device 210 may transmit an authorization response indicating approval of the financial transaction. In some embodiments, step 614 may further include updating, in the transaction database 202, the historical data to include the transaction data for the financial transaction, and identifying, by the processing device 206, an update use threshold 402 associated with the payment card use control based on an application of the selected threshold model 400 to the updated historical data. In a further embodiment, identifying an updated use threshold may include identifying the updated use threshold at a predetermined time. In an even further embodiment, the predetermined time may be a time interval. In yet a further embodiment, the time interval may be identified by a user 102 associated with the payment card 104.

In some embodiments, identifying a use threshold may further include identifying an alert threshold based on a mean payment card use control value based on the historical data stored in the transaction database 202. In a further embodiment, if the use threshold is exceeded, the transmitting device 210 may transmit a notification to a user (e.g., the cardholder 102) associated with the payment card 104 if the alert threshold is exceeded based on the transaction data. In an even further embodiment, the notification may include at least a portion of the transaction data related to the payment card use control.

### Computer System Architecture

FIG. 7 illustrates a computer system 700 in which embodiments of the present disclosure, or portions thereof, may be implemented as computer-readable code. For example, the issuer 106, the merchant 108, the acquirer 110, and the processing server 114 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3A, 3B, and 6.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multiprocessor machines. In addition, in some embodiments the order of operations may be rearranged without departing from the spirit of the disclosed subject matter.

Processor device 704 may be a special purpose or a general purpose processor device. The processor device 704 may be connected to a communication infrastructure 706, such as a bus, message queue, network, multi-core message-passing scheme, etc. The network (e.g., the payment network 112) may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive, the removable storage unit 718 may be a floppy disk. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

Computer program medium and computer usable medium may refer to memories, such as the main memory 708 and secondary memory 710, which may be memory semiconductors (e.g. DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3A, 3B, and 6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

Techniques consistent with the present disclosure provide, among other features, systems and methods for the identification of merchant debit routing tables. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

1. A method for providing an automatic threshold for payment card controls, comprising:
storing, in a transaction database, historical data for a plurality of financial transactions involving a payment card;
receiving, by a receiving device, an automatic threshold request, wherein the automatic threshold request includes at least an indication of a threshold model selected from a plurality of threshold models and a payment card use control;
identifying, by a processing device, a use threshold associated with the payment card use control based on an application of the selected threshold model to the historical data stored in the transaction database;
receiving, by the receiving device, an authorization request for a financial transaction involving the payment card, wherein the authorization request includes transaction data related to the financial transaction; and
identifying, by the processing device, if the use threshold is exceeded based on the transaction data and the payment card use control, wherein
if the use threshold is exceeded, transmitting, by a transmitting device, an authorization response indicating the threshold has been or will be exceeded by the financial transaction, and
if the use threshold is not exceeded, transmitting, by the transmitting device, an authorization response indicating approval with respect to not exceeding the threshold of the financial transaction.

2. The method of claim 1, wherein, if the use threshold is not exceeded, the method further comprises:
updating, in the transaction database, the historical data to include the transaction data for the financial transaction, and
identifying, by the processing device, an updated use threshold associated with the payment card use control based on an application of the selected threshold model to the updated historical data.

3. The method of claim 1, wherein the historical data includes, for each financial transaction of the plurality of financial transactions, at least one of: transaction amount, merchant name, merchant industry, geographic location, purchase order number, transaction time, transaction date, gratuity, and expense type.

4. The method of claim 1, wherein the transaction data related to the financial transaction includes at least one of: transaction amount, merchant name, merchant industry, geographic location, purchase order number, transaction time, transaction date, gratuity, and expense type.

5. The method of claim 1, wherein the plurality of threshold models includes at least one of: an outlier percentage, a Gaussian model, Chauvenet's criterion, Grubbs' test, Peirce's criterion, a value relative to a mean payment card use control value, and a value of standard deviations.

6. The method of claim 1, wherein identifying a use threshold further comprises identifying an alert threshold based on a mean payment card use control value based on the historical data stored in the transaction database, and wherein, if the if the use threshold is exceeded, the method further comprises:
transmitting, by the transmitting device, a notification to a user associated with the payment card if the alert threshold is exceeded based on the transaction data.

7. The method of claim 6, wherein the notification includes at least a portion of the transaction data related to the payment card use control.

8. The method of claim 1, wherein the use threshold is at least one of: an upper use threshold and a lower use threshold.

9. The method of claim 1, wherein the payment card use control is a control on at least one of: transaction amount, merchant name, merchant industry, geographic location, purchase order number, transaction time, transaction date, gratuity, expense type, and transaction frequency.

10. The method of claim 2, wherein identifying an updated use threshold includes identifying the updated use threshold at a predetermined time.

11. The method of claim 10, wherein the predetermined time is a time interval.

12. The method of claim 11, wherein the time interval is identified by a user associated with the payment card.

13. A system for providing an automatic threshold for payment card controls, comprising:
a transmitting device;
a transaction database configured to store historical data for a plurality of financial transactions involving a payment card;
a receiving device configured to receive an automatic threshold request, wherein the automatic threshold request includes at least an indication of a threshold model selected from a plurality of threshold models and a payment card use control; and
a processing device configured to identify a use threshold associated with the payment card use control based on an application of the selected threshold model to the historical data stored in the transaction database, wherein
the receiving device is further configured to receive an authorization request for a financial transaction involving the payment card, the authorization request including transaction data related to the financial transactions,
the processing device is further configured to identify if the use threshold is exceeded based on the transaction data and the payment card use control, and
if the use threshold is exceeded, the transmitting device is configured to transmit an authorization response indicating the threshold has been or will be exceeded by the financial transactions, and
if the use threshold is not exceeded, the transmitting device is configured to transmit an authorization response indicating threshold has not been or will not be exceeded by approval of the financial transactions.

14. The system of claim 13, wherein, if the use threshold is not exceeded, the processing device is further configured to update, in the transaction database, the historical data to include the transaction data for the financial transaction, and identify an updated use threshold associated with the payment card use control based on an application of the selected threshold model to the updated historical data.

15. The system of claim 13, wherein the historical data includes, for each financial transaction of the plurality of financial transactions, at least one of: transaction amount, merchant name, merchant industry, geographic location, purchase order number, transaction time, transaction date, gratuity, and expense type.

16. The system of claim 13, wherein the transaction data related to the financial transaction includes at least one of: transaction amount, merchant name, merchant industry, geographic location, purchase order number, transaction time, transaction date, gratuity, and expense type.

17. The system of claim 13, wherein the plurality of threshold models includes at least one of: an outlier percentage, a Gaussian model, Chauvenet's criterion, Grubbs' test, Peirce's criterion, a value relative to a mean payment card use control value, and a value of standard deviations.

18. The system of claim 13, wherein
the processing device is further configured to identify an alert threshold based on a mean payment card use control value based on the historical data stored in the transaction database, and
if the use threshold is exceeded the transmitting device is further configured to transmit a notification to a user associated with the payment card if the alert threshold is exceeded based on the transaction data.

19. The system of claim 18, wherein the notification includes at least a portion of the transaction data related to the payment card use control.

20. The system of claim 13, wherein the use threshold is at least one of: an upper use threshold and a lower use threshold.

21. The system of claim 13, wherein the payment card use control is a control on at least one of: transaction amount, merchant name, merchant industry, geographic location, purchase order number, transaction time, transaction date, gratuity, expense type, and transaction frequency.

22. The system of claim 14, wherein the processing device is further configured to identify the updated use threshold at a predetermined time.

23. The system of claim 22, wherein the predetermined time is a time interval.

24. The system of claim 23, wherein the time interval is identified by a user associated with the payment card.
